(19) United States
(12) Patent Application Publication
(10) Pub. No.: US 2010/0213428 A1
(43) Pub. Date: Aug. 26, 2010

(54) AUTOMOBILE JACKING SYSTEM

(76) Inventor: Mario Ortiz, Prineville, OR (US)

Correspondence Address: LAW OFFICE OF JERRY D. HAYNES , P.A, P.O. Box 350392, Fort Lauderdale, FL, 33335, US

(21) Appl. No.: 12/390,938

(22) Filed: Feb. 23, 2009

(51) Int. Cl. B60S 9/10

(52) U.S. Cl. 254/423

(57) ABSTRACT

The present invention relates to an automated jacking system for lifting an automobile comprising: a plurality of mounted jacks, wherein each mounted jack includes an I-shaped assembly; a control means; and an activation means. Each mounted jack is firmly attached to each end of each axle of the automobile. The control means may include either a control panel within the interior of the automobile or a remote handheld control device. The activation means includes a motor on each mounted jack, wherein each mounted jack includes a base, a mounting bracket and a cylindrical body. The cylindrical body connects the mounting bracket to the base. A plurality of bolts firmly attaches each mounted jack to the respective axle. The mounted jacks according to the present invention may use either pneumatic or hydraulic means of power within the cylindrical body.

### BACKGROUND OF THE INVENTION

1. Field of Invention

The present invention relates to an automobile jacking system, which provides an automated and powered jacking system for an automobile.

2. Description of Related Art

The automobile is the principal mode of transportation throughout modern society. One of the drawbacks of automobile use is the inevitable mechanical breakdowns that occur over a course of time. Many of the mechanical problems may be addressed by a professional mechanic and therefore do not require any or minimal intervention by the owner or user of an automobile. On occasion, however the owner or driver of a vehicle may encounter a flat tire and therefore must perform probably the most common temporary repair, changing a flat tire. The conventional method of changing a flat tire requires using a hand jack and manually jacking the vehicle to an up position. The jacks commonly used attach to the frame or bumper, then are manually raised to an up position and the flat tire is removed and replaced. This method can be the laborious and some individuals may have trouble performing this task. Therefore it would be advantageous to have an apparatus or method to alleviate or eliminate the physical labor associated with this task. The prior art discloses some apparatuses and methods that utilize power automation to lift an automobile to gain access to the flat tire and perform the necessary change.

In particular, U.S. Pat. No. 6,237,953 discloses an automatic jack and wheel changing system, which includes a retractable jack driven by electric motor that is permanently attached to the vehicle. The jacking system of the '953 patent includes and describes a scissor jack system where the scissor jack is attached to the frame and a hub and axle assembly is featured which allows the user to remove the tires without the use of any mechanical tools. The '953 patent states that up to four jacks may be employed on the vehicle to facilitate the system as disclosed. However, the preferred embodiment is a scissor jack, which is positioned near the frame of a vehicle.

U.S. Pat. No. 4,067,543 discloses a jack assembly for vehicles that includes an electrically operated retractable jack that is mounted upon a vehicle. The jacking system disclosed in the '543 patent relates to vertical jacks that are positioned around the perimeter of a trailer that provide a means to level the trailer for an extended period of time. The jacking system of the '543 patent does not disclose a jack that maneuvers the vehicle to a sufficient height for removal and replacement of wheels or tires.

U.S. Pat. No. 2,131,296 discloses an electrical vehicle jack which provides a system of jacks installed as an accessory to a motor vehicle. The jacking system of the '296 patent is an electrical-driven jacking unit where the jacks are constructed of the threaded drive screw and a bracket assembly with a gearing system that engages the screw for rotation.

Some of the drawbacks of the prior art include the types of jacks that are used in the power systems, which are likely to have a high failure rate, and are therefore not effective for use over an extended period of time.

### SUMMARY OF THE INVENTION

The present invention relates to an automated jacking system for lifting an automobile comprising: a plurality of mounted jacks, wherein each mounted jack includes a I-shaped assembly; a control means; and an activation means. Each mounted jack is firmly attached to each end of each axle of the automobile. The control means may include either a control panel within the interior of the automobile or a remote handheld control device. The activation means includes a motor on each mounted jack, wherein each mounted jack includes a base, a mounting bracket and a cylindrical body. The cylindrical body connects the mounting bracket to the base. A plurality of bolts firmly attaches each mounted jack to the respective axle. The mounted jacks according to the present invention may use either pneumatic or hydraulic means of power within the cylindrical body.

### BRIEF DESCRIPTION OF DRAWINGS

FIG. 1 shows an overview of the automobile jacking system according to the present invention.

FIG. 2 shows an exemplary jack according to the present invention.

### DETAILS AND DESCRIPTION

The present invention discloses a unique automated jacking system for installation on an automobile. The present invention provides jacks which are positioned on the vehicle axles and provide a means to automatically lift each wheel as desired by the user. The automated jacking system according to present invention therefore eliminates the need for physical labor in order to perform the changing of a tire. The jacking system conveniently raises the desired wheel to an up position and allows for the removal and installation of a new tire.

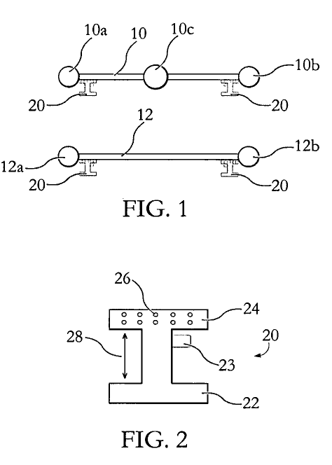

As depicted in FIG. 1, a mounted jack is positioned on the wheel axle of a vehicle near the wheel bearings of each wheel. A rear axle 10 is shown which includes a left wheel bearing 10a and a right wheel bearing 10b. Also shown on the rear axle 10 is a designation for a transmission 10c. At each end of the rear axle 10 a mounted jack 20 is positioned. The mounted jack 20 is a motorized jack which transfers power along the vertical axis and effectively raises the desired wheel to the up position. Also shown in FIG. 1 is a front axle 12 that includes a left wheel bearing 12a and a right wheel bearing 12b. Just inside the wheel bearings 12a,12b along the front axle 12, two mounted jacks are positioned according to the present invention. The mounted jacks 20 provide a means to raise the desired wheel along the front axle to a up position and therefore provide a means for the removal and replacement of a tire.

FIG. 2 shows a detailed view of the mounted jack 20. The mounted jack 20 is mounted directly to the desired wheel axle by using a mounting bracket 24 and mounting bolts 26. At the opposite end of the mounting bracket 24 lies a jack base 22. A cylindrical body joins the mounting bracket 24 and jack base 22 to form an I-shaped jack. An electrical motor 23 is attached to the cylindrical body between the mounting bracket 24 and the jack base 22. The direction of expansion 28 is depicted along the axis of the cylindrical body of the mounted jack 20. The mounted jack 20 may be activated through an electrical control means to raised the jack to an up position. Once raised to the up position, the mounted jack 20 remains up and locked until deactivated and lowered after completion of the tire change.

The mounted jack 20 uniquely has a lifting means to raise the desired wheel to an up position. The I-shape of the mounted jack 20 ensures that the mounted jack provides a stable and firm support means while the wheel is in a raised position. The mounted jack 20 may be driven through hydraulics or pneumatic means of power. The movement of the jack is activated through an electric motor 23. The height of the jack 20 in the up position may be vary and at least be suitable for the size of tires and axle height on the vehicle that the mounted jack 20 is installed upon. Further the mounting bolts 26 may be used to bolt the mounted jack onto the respective axle. The bolts 26 may include an axle reinforcement means in order to attach and firmly secure the mounted jack 20 into place.

The present invention consequently alleviates the physical labor that is associated with raising a car to up position in order to change a flat tire. The mounted jack 20 is distinguished from the prior art due to its unique design that does not necessitate the need for complicated gearing and bracketing systems in order to raise the mounted jack to an up position. The mounted jack 20 uses internal hydraulics or pneumatics actuated by the motor 23 to lift the wheel to an up position and to securely lock it in the up position during the removal and replacement of the tire.

The control mechanisms for the mounted jack 20 may include switches available on the interior panel of the vehicle or a remotely powered control unit that activates the desired mounted jack upon actuation.

The mounted jack 20 may be installed on existing vehicles and also provided as an accessory on new vehicles. The mounted jack 20 according to the present invention consequently provides a unique and effective jack that alleviates an age-old problem of motor vehicle use.

What is claimed is:

1. An automated jacking system for lifting an automobile comprising:
a. a plurality of mounted jacks, wherein each mounted jack includes an I-shaped assembly;
b. a control means; and
c. an activation means.

2. The automated jacking system according to claim 1, wherein a mounted jack is firmly attached to each end of each axle of the automobile.

3. The automated jacking system according to claim 1, wherein the control means includes a control panel within the interior of the automobile.

4. The automated jacking system according to claim 1, wherein the control means includes a remote handheld control device.

5. The automated jacking system according to claim 1, wherein the activation means includes a motor on each mounted jack.

6. The automated jacking system according to claim 1, wherein each mounted jack includes a base, a mounting bracket and a cylindrical body where the cylindrical body connects the mounting bracket to the base.

7. The automated jacking system according to claim 6, further comprising a plurality of bolts that firmly attach each mounted jack to the respective axle.

8. The automated jacking system according to claim 6, wherein at least one of a pneumatic and hydraulic means of power lies within the cylindrical body.

9. The automated jacking system according to claim 7, further comprising an axle reinforcement means, where said reinforcement means assists in attaching the mounting jacks to the axles.
